(19) United States
(12) Patent Application Publication
(10) Pub. No.: US 2023/0077115 A1
(43) Pub. Date: Mar. 9, 2023

(54) METHOD AND SYSTEM FOR RECOMMENDING IMPROVEMENT OPPORTUNITIES IN ENTERPRISE OPERATIONS

(71) Applicant: Tata Consultancy Services Limited, Mumbai (IN)

(72) Inventors: GAYATHRI EKAMBARAM, Chennai (IN); MOHAMMED MUSTHAFA SOUKATH ALI, Chennai (IN); MUHAMMAD TABREZ, Chennai (IN); SARANYA KALIAPPAN, Chennai (IN); MOHANA MURALI PRASAD MAGANTI, Chennai (IN)

(73) Assignee: Tata Consultancy Services Limited, Mumbai (IN)

(21) Appl. No.: 17/817,148

(22) Filed: Aug. 3, 2022

(30) Foreign Application Priority Data
Aug. 4, 2021 (IN) 202121035141

(51) Int. Cl. G06Q 10/06

(52) U.S. Cl. CPC G06Q 10/06393

(57) ABSTRACT

This disclosure relates generally to method and system for recommending improvement opportunities in enterprise operations. Due to recent advancement, cognitive business operations face challenges in identifying new business opportunities. The present disclosure receives statistics about performance data as inputs from each business operations to identify gaps of improvement specific to the context using an agility recommender technique. The received performance data are analyzed using a cognitive data analyzer comprising a structured data and an unstructured data which is an indicative factor of enterprise operations agility. The agility recommender technique computes the contextual factor based on a plurality of contextual parameters, a contextual intercept, and a coefficient of the contextual intercepts. Further, a set of improvement opportunities are determined to recommend the enterprise operations based on a plurality of agility performance parameters deviation identified from the set of performance data compared with historical data.

### CROSS-REFERENCE TO RELATED APPLICATIONS AND PRIORITY

This U.S. patent application claims priority under 35 U.S.C § 119 to: Indian patent Application no. 202121035141, filed on Aug. 4, 2021. The entire contents of the aforementioned application are incorporated herein by reference.

### TECHNICAL FIELD

The disclosure herein generally relates to improvement opportunities, and, more particularly, to method and system for recommending improvement opportunities in enterprise operations.

### BACKGROUND

Businesses are struggling on multiple fronts to get on big data led frontier of business performance optimization. Identifying business opportunities in a market can be a difficult task for potential lucrative venture. Due to recent advancement in information technology and growing popularity of internet, a vast amount of information is available in digital form. Hence, cognitive business opportunities essentially integrate operation services across both business process services (BPS) and IT infrastructure (ITIS). With the ever-growing volume of information online, recommender systems have been a useful tool to overcome information overload. In CBO industry because of voluminous and repetitive nature of work, teams do not get enough time to improve their work in modernizing the technology, updating skillset, and reimagining processes. Conventional solutions track defects in processes to generate key performance indicators based on quality metrics and measurements resulting imperative to function with imperfect processes. Also, such methods face challenges in identifying and assessing business opportunities for prospective customers in relatively new market. In such scenarios, improvement opportunities for businesses with modernization of technology utilizes a recommender system to provide users with recommendations based on various qualitative metrics.

### SUMMARY

Embodiments of the present disclosure present technological improvements as solutions to one or more of the above-mentioned technical problems recognized by the inventors in conventional systems. For example, in one embodiment, a system for recommending improvement opportunities in enterprise operations is provided. The system includes receiving a set of performance data being associated with enterprise operations. Here, the set of performance data includes a structured data, and an unstructured data. Further, a cognitive data analyser analyses the set of performance data with a set of benchmark value which is an indicative factor of an enterprise operations agility. Further, a plurality of agility performance parameters are computed based on a deviation identified from the set of performance data compared with the set of benchmark value using an agility recommender technique, wherein the plurality of agility performance parameters comprises a contextual factor and an affinity factor. Further, a set of improvement opportunities are determined to recommend the enterprise operations based on the plurality of agility performance parameters compared with historical data.

The agility recommender technique performs the steps to compute, the contextual factor based on at least one of (i) a plurality of contextual parameters, (ii) a contextual intercept, and (iii) a coefficient of the contextual intercepts, wherein the plurality of contextual parameters are extracted from the set of performance data. Then, the affinity factor is computed based on (i) a plurality of affinity parameters, and (ii) a contextual delta. The plurality of contextual parameters comprises a team size, a team skill, a line of business, and a technical stack and the plurality of affinity parameters comprises (i) a measurement attribute, and (ii) a customer feedback. The measurement attribute is a weighted average of a plurality of performance attributes falling within a predefined range.

In another aspect, a method for recommending improvement opportunities in enterprise operations is provided. The method includes receiving a set of performance data being associated with enterprise operations. Here, the set of performance data includes a structured data, and an unstructured data. Further, a cognitive data analyser analyses the set of performance data with a set of benchmark value which is an indicative factor of an enterprise operations agility. Further, a plurality of agility performance parameters are computed based on a deviation identified from the set of performance data compared with the set of benchmark value using an agility recommender technique, wherein the plurality of agility performance parameters comprises a contextual factor and an affinity factor. Further, a set of improvement opportunities are determined to recommend the enterprise operations based on the plurality of agility performance parameters compared with historical data.

The agility recommender technique performs the steps to compute, the contextual factor based on at least one of (i) a plurality of contextual parameters, (ii) a contextual intercept, and (iii) a coefficient of the contextual intercepts, wherein the plurality of contextual parameters are extracted from the set of performance data. Then, the affinity factor is computed based on (i) a plurality of affinity parameters, and (ii) a contextual delta. The plurality of contextual parameters comprises a team size, a team skill, a line of business, and a technical stack and the plurality of affinity parameters comprises (i) a measurement attribute, and (ii) a customer feedback. The measurement attribute is a weighted average of a plurality of performance attributes falling within a predefined range.

In yet another aspect, a non-transitory computer readable medium provides one or more non-transitory machine-readable information storage mediums comprising one or more instructions, which when executed by one or more hardware processors perform actions includes an I/O interface and a memory coupled to the processor is capable of executing programmed instructions stored in the processor in the memory to receive a set of performance data being associated with enterprise operations. Here, the set of performance data includes a structured data, and an unstructured data. Further, a cognitive data analyser analyses the set of performance data with a set of benchmark value which is an indicative factor of an enterprise operations agility. Further, a plurality of agility performance parameters are computed based on a deviation identified from the set of performance data compared with the set of benchmark value using an agility recommender technique, wherein the plurality of agility performance parameters comprises a contextual factor and an affinity factor. Further, a set of improvement opportunities are determined to recommend the enterprise operations based on the plurality of agility performance parameters compared with historical data.

The agility recommender technique performs the steps to compute, the contextual factor based on at least one of (i) a plurality of contextual parameters, (ii) a contextual intercept, and (iii) a coefficient of the contextual intercepts, wherein the plurality of contextual parameters are extracted from the set of performance data. Then, the affinity factor is computed based on (i) a plurality of affinity parameters, and (ii) a contextual delta. The plurality of contextual parameters comprises a team size, a team skill, a line of business, and a technical stack and the plurality of affinity parameters comprises (i) a measurement attribute, and (ii) a customer feedback. The measurement attribute is a weighted average of a plurality of performance attributes falling within a predefined range.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an agility recommender system, in accordance with some embodiments of the present disclosure

FIG. 2 illustrates a functional block diagram for recommending improvement opportunities with agility in enterprise operations using the agility recommender system of FIG. 1, in accordance with some embodiments of the present disclosure.

FIG. 3 illustrates a flow diagram of the method for recommending improvement opportunities in enterprise operations using the agility recommender system of FIG. 1, in accordance with some embodiments of the present disclosure.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

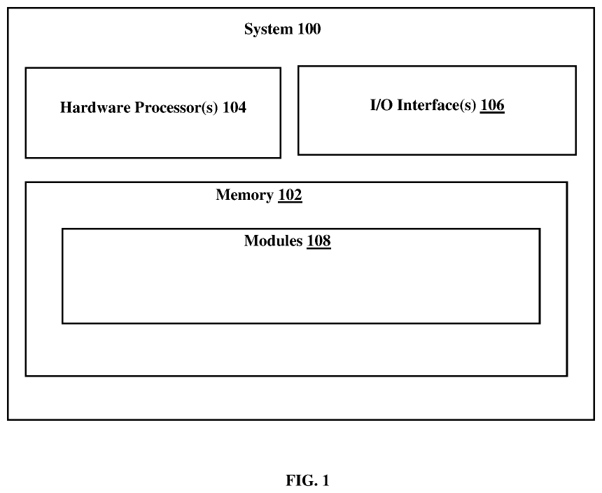

Embodiments herein provides a method and system for recommending improvement opportunities in enterprise operations. The method disclosed, enables to recommend opportunities for various business improvements associated with enterprise operations. The system herein may be alternatively referred as an agility recommender system interfaced with various source applications used in the enterprise operations. The agility recommender system receives statistics about performance data as inputs from each business operations to identify gaps of improvement specific to the context. The received performance data are analyzed using a cognitive data analyzer comprising a structured data and an unstructured data which is an indicative factor of enterprise operations agility. It may be understood that the recommended opportunities are feasible to the business context type of any enterprise operations. Also, the system and method of the present disclosure is accurate, time efficient, and scalable for agility operations. The disclosed system is further explained with the method as described in conjunction with FIG. 1 to FIG. 3 below.

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 illustrates an exemplary block diagram of a system (alternatively referred as an agility recommender system), in accordance with some embodiments of the present disclosure. In an embodiment, the asset monitoring system 100 includes processor (s) 104, communication interface (s), alternatively referred as or input/output (I/O) interface(s) 106, and one or more data storage devices or memory 102 operatively coupled to the processor (s) 104. The system 100, with the processor(s) is configured to execute functions of one or more functional blocks of the system 100. Referring to the components of the system 100, in an embodiment, the processor (s) 104 can be one or more hardware processors 104. In an embodiment, the one or more hardware processors 104 can be implemented as one or more microprocessors, microcomputers, microcontrollers, digital signal processors, central processing units, state machines, logic circuitries, and/or any devices that manipulate signals based on operational instructions. Among other capabilities, the processor(s) 104 is configured to fetch and execute computer-readable instructions stored in the memory. In an embodiment, the system 100 can be implemented in a variety of computing systems, such as laptop computers, notebooks, hand-held devices, workstations, mainframe computers, servers, a network cloud, and the like.

The I/O interface(s) 106 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface (s) 106 can include one or more ports for connecting a number of devices (nodes) of the system 100 to one another or to another server. The memory 102 may include any computer-readable medium known in the art including, for example, volatile memory, such as static random-access memory (SRAM) and dynamic random-access memory (DRAM), and/or nonvolatile memory, such as read only memory (ROM), erasable programmable ROM, flash memories, hard disks, optical disks, and magnetic tapes. The modules 108 can be an Integrated Circuit (IC) (not shown), external to the memory 102, implemented using a Field-Programmable Gate Array (FPGA) or an Application-Specific Integrated Circuit (ASIC). The names (or expressions or terms) of the modules of functional block within the modules 108 referred herein, are used for explanation, and are not construed to be limitation(s).

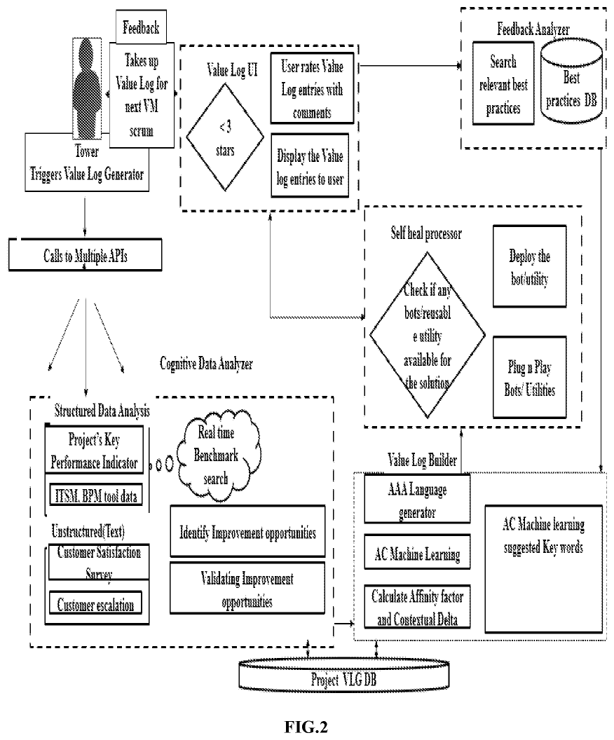

FIG. 2 illustrates a functional block diagram for recommending improvement opportunities with agility in enterprise operations using the agility recommender system of FIG. 1, in accordance with some embodiments of the present disclosure. The FIG. 2 includes a cognitive data analyzer module, a value log builder module, a self-heal processor module, and a feedback analyzer module. The cognitive data analyzer module acts as an interface with various source business applications to obtain current statistics about the type of project of each business comprising a project demographics for analysis. The cognitive data analyzer analyses the set of performance data based on a set of benchmark value which is an indicative factor of enterprise operations agility. The value log builder module creates value log entry for recommended solution using an agility recommender technique which further uses the processed feedback parameters obtained from feedback analyzer module. The feedback analyzer module receives feedback from the value log user interface for entries in database associated with the system. The self-heal processor module checks the availability of bots matching the value of log entries.

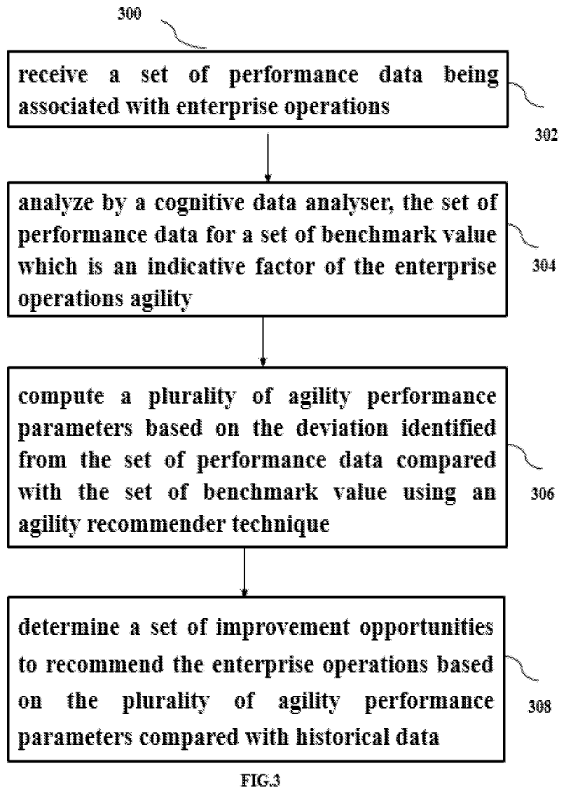

FIG. 3 illustrates a flow diagram of the method for recommending improvement opportunities in enterprise operations using the agility recommender system of FIG. 1, in accordance with some embodiments of the present disclosure. In an embodiment, the system 100 comprises one or more data storage devices or the memory 102 operatively coupled to the processor(s) 104 and is configured to store instructions for execution of steps of the method 300 by the processor(s) or one or more hardware processors 104. The steps of the method 300 of the present disclosure will now be explained with reference to the components or blocks of the system 100 as depicted in FIG. 1 and the steps of flow diagram as depicted in FIG. 3. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

Referring now to the steps of the method 300, at step 302, the one or more hardware processors 104 to receive a set of performance data being associated with enterprise operations, wherein the set of performance data includes a structured data, and an unstructured data. The agility recommender system is depicted considering an example of a BPS operations team working for an insurance customer which processes claims to improve efficiency. In such scenario, the system receives a set of performance data comprising a key performance indicator (KPI), benchmark data, and a customer satisfaction survey data from the project performance corresponding to the business associated with the enterprise operations. The benchmark data is the cutoff value corresponding to the parameter of the business process. On receiving these inputs, the agility recommender system calls multiple application programming interface (API's) to process performance data to recommend improvement opportunities associated with the enterprise operations.

Referring now to the steps of the method 300, at step 304, the one or more hardware processors 104 to analyze the set of performance data with a set of benchmark value which is an indicative factor of an enterprise operations agility using a cognitive data analyser. Here, the set of performance data are analysed with dynamic benchmark value corresponding to the type of enterprise operations. Referring now to the above example, the benchmark data for the BPS operations example, the insurance customer domain turnaround time is of about two weeks, the enterprise operations agility includes the customer satisfaction index (CSI) is of about 89 and an aspirational customer satisfaction index is of about 92. For the set of performance data inputs, the system compares with the benchmark data dynamically to identify deviations associated with the performance data of specific enterprise business operations. The cognitive data analyzer compares the turnaround time with the benchmark data corresponding to the business project type and for the greater turnaround time of insurance project is marked. Further another level of validation is performed using an unstructured data. The aspirational customer satisfaction index value is less then string analysis function is triggered for the customer satisfaction survey (CSS).

Referring now to the steps of the method 300, at step 306, the one or more hardware processors 104 to compute a plurality of agility performance parameters via the one or more hardware processors, based on a deviation identified from the set of performance data compared with the set of benchmark value using an agility recommender technique, wherein the plurality of agility performance parameters comprises a contextual factor and an affinity factor. Here, for the above example of insurance customer, the set of analyzed performance data obtained from the cognitive data analyzer are fed to the agility recommender technique to identify deviation associated with the project. The agility recommender technique comprises computing the contextual factor based on at least one of (i) a plurality of contextual parameters, (ii) a contextual intercept, and (iii) a coefficient of the contextual intercepts, wherein the plurality of contextual parameters are extracted from the set of performance data. The plurality of contextual parameters comprises a Team size (p₁), a Team skill (p₂), a Line of business (p₃), and a Technical stack (p₄) which is denoted as represented in equation 1,

$$\frac{( {p}_{1} . {w}_{1} + {p}_{2} . {w}_{2} + {…}_{…} {p}_{n} . {w}_{n} )}{w} \qquad equation 1$$

where, p is the parameter having value of about zero or one, w is the weightage, and for each contextual parameter weightage is assigned. It is to be noted that the plurality of contextual parameters changes according to the type of business enterprise operations. The contextual intercept is computed using a sklearn import linear model having a regression model with trained data denoted in equation 2,

conceptual intercept( )=rern.intercept equation 2

Further, the affinity factor is computed based on (i) a plurality of affinity parameters and (ii) a contextual delta. The plurality of affinity parameters comprises (i) a measurement attribute, and (ii) a customer feedback. Here, the measurement attribute is a weighted average of a plurality of performance attributes falling within a predefined range, wherein the predefined range falls within the limit between zero and one 0<predefined range <1. The plurality of performance attributes comprises of an accuracy, a turnaround time, a productivity, an average handling time, a first pass yield, a first time right, a mean time to resolve, and a resolution time. It is to be noted that the plurality of performance attributes changes according to the type of business enterprise operations. Here, the measurement attribute is sum of all attributes as denoted below in equation 3,

$$\frac{{a}_{1} + {a}_{2} + {…}_{…} {a}_{n}}{n} \qquad equation 3$$

where, a is the attribute validated more than one data source applications, for example if the accuracy value validated more than one, source value ranges either zero or one. The measurement attribute of previous iterations is represented as equation 4,

$$\frac{{r}_{1} + {r}_{2} + {…}_{…} {r}_{m}}{m} \qquad equation 4$$

where, r is the range between a predefined ratings.
The contextual delta (c_{d}) is computed based on the ratio of deviation identified from the plurality of contextual parameters and the weightage of the plurality of contextual parameters with the sum of weightage of contextual parameters as denoted in equation 5,

$${c}_{d} = \frac{( {d}_{1} . {w}_{1} + {d}_{2} . {w}_{2} + {…}_{…} {d}_{n} . {w}_{n} )}{( {w}_{1} + {w}_{2} + … . {w}_{n} )} \qquad equation 5$$

The team size delta is denoted as below in equation 6,

$${d}_{1} ( Team size delta ) = \frac{{dp}_{1} - {dc}_{1}}{{dp}_{1}} \qquad equation 6$$

where, dp₁ is the previous team size and dc₁ is the current team size weightage.
The team skill delta is denoted as below in equation 7,

$${d}_{2} ( Team skill delta ) = \frac{100 - \% of match}{100} \qquad equation 7$$

where, % of match is the list of string comparison (Training data skill set, current data skill set)
The project type skill delta is denoted as below in equation 8,

$${d}_{3} ( Project type delta ) = \frac{100 - \% of match}{100} \qquad equation 8$$

where, % of match is the list of string comparison (Training project type, current project skill set)
The tech stack delta is denoted as below in equation 9,

$${d}_{4} ( Tech stack delta ) = \frac{100 - \% of match}{100} \qquad equation 9$$

where, % of match is the list of string comparison (Training tech stack, current tech stack)
The line of business delta stack delta is denoted as below in equation 10,

$${d}_{5} ( Line of business delta ) = \frac{100 - \% of match}{100} \qquad equation 10$$

where, % of match is the list of string comparison (Training LOB, current LOB)

Referring now to the steps of the method 300, at step 308, the one or more hardware processors 104 to determine a set of improvement opportunities to recommend the enterprise operations based on the plurality of agility performance parameters compared with historical data. The above computed plurality of agility performance parameters is fetched to compare with the historical data which are prestored in the system. The plurality of agility performance parameters comprises a contextual factor and an affinity factor. The step further fetches the contextual factor value and the affinity factor value to compare with the historical data.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein addresses unresolved problem of improvement opportunities. The embodiment thus provides method and system for recommending improvement opportunities in enterprise operations. Moreover, the embodiments herein further provide an accurate identification of improvement opportunities which results in better benefits of business operations with greater agility. The proposed method is designed for various business operations requirement which necessarily requires improvements for recommending new opportunities with precision of agility recommender technique there by increases performance. The present disclosure is a technology and domain agnostic for enterprise operations across domains. The method of the present disclosure receives statistics about performance data as inputs from each business operations to identify gaps of improvement specific to the context using an agility recommender technique. The received performance data are analyzed using a cognitive data analyzer comprising a structured data and an unstructured data which is an indicative factor of enterprise operations agility. The agility recommender technique computes the contextual factor based on a plurality of contextual parameters, a contextual intercept, and a coefficient of the contextual intercepts.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method to recommend improvement opportunities in enterprise operations, the method comprising:
receiving, via one or more hardware processors, a set of performance data being associated with enterprise operations, wherein the set of performance data includes a structured data, and an unstructured data;
analyzing, by a cognitive data analyser via the one or more hardware processors, the set of performance data with a set of benchmark value which is an indicative factor of an enterprise operations agility;
computing, a plurality of agility performance parameters via the one or more hardware processors, based on a deviation identified from the set of performance data compared with the set of benchmark value using an agility recommender technique, wherein the plurality of agility performance parameters comprises a contextual factor and an affinity factor; and
determining, via the one or more hardware processors, a set of improvement opportunities to recommend the enterprise operations based on the plurality of agility performance parameters compared with historical data.

2. The processor implemented method as claimed in claim 1, wherein the agility recommender technique comprises:
computing, the contextual factor based on at least one of (i) a plurality of contextual parameters, (ii) a contextual intercept, and (iii) a coefficient of the contextual intercepts, wherein the plurality of contextual parameters are extracted from the set of performance data; and
computing, the affinity factor based on (i) a plurality of affinity parameters, and (ii) a contextual delta.

3. The processor implemented method as claimed in claim 2, wherein the plurality of contextual parameters comprises a team size, a team skill, a line of business, and a technical stack.

4. The processor implemented method as claimed in claim 2, wherein the plurality of affinity parameters comprises (i) a measurement attribute, and (ii) customer feedback.

5. The processor implemented method as claimed in claim 4, wherein the measurement attribute is a weighted average of a plurality of performance attributes falling within a predefined range.

6. The processor implemented method as claimed in claim 5, wherein the plurality of performance attributes comprises of an accuracy, a turnaround time, a productivity, an average handling time, a first pass yield, a first time right, a mean time to resolve, and a resolution time.

7. The processor implemented method as claimed in claim 2, wherein the contextual delta is computed based on the ratio of deviation identified from the plurality of contextual parameters and the weightage of the plurality of contextual parameters with the sum of weightage of contextual parameters.

8. A system to recommend improvement opportunities in enterprise operations, comprising:
a memory (102) storing instructions;
one or more communication interfaces (106); and
one or more hardware processors (104) coupled to the memory (102) via the one or more communication interfaces (106), wherein the one or more hardware processors (104) are configured by the instructions to:
receive, a set of performance data being associated with enterprise operations, wherein the set of performance data includes a structured data, and an unstructured data;
analyze by a cognitive data analyser, the set of performance data with a set of benchmark value which is an indicative factor of an enterprise operations agility;
compute, a plurality of agility performance parameters based on a deviation identified from the set of performance data compared with the set of benchmark value using an agility recommender technique, wherein the plurality of performance parameters comprises a contextual factor and an affinity factor; and
determine, a set of improvement opportunities to recommend the enterprise operations based on the plurality of agility performance parameters compared with historical data.

9. The system as claimed in claim 8, wherein the agility recommender technique comprises:
computing, the contextual factor based on at least one of (i) a plurality of contextual parameters, (ii) a contextual intercept, and (iii) a coefficient of the contextual intercepts, wherein the plurality of contextual parameters are extracted from the set of performance data; and
computing, the affinity factor based on (i) a plurality of affinity parameters, and (ii) a contextual delta.

10. The system as claimed in claim 9, wherein the plurality of contextual parameters comprises a team size, a team skill, a line of business, and a technical stack.

11. The system as claimed in claim 9, wherein the plurality of affinity parameters comprises (i) a measurement attribute, and (ii) customer feedback.

12. The system as claimed in claim 11, wherein the measurement attribute is a weighted average of a plurality of performance attributes falling within a predefined range.

13. The system as claimed in claim 12, wherein the plurality of performance attributes comprises of an accuracy, a turnaround time, a productivity, an average handling time, a first pass yield, a first time right, a mean time to resolve, and a resolution time.

14. The system as claimed in claim 9, wherein the contextual delta is computed based on the ratio of deviation identified from the plurality of contextual parameters and the weightage of the plurality of contextual parameters with the sum of weightage of contextual parameters.

15. One or more non-transitory machine-readable information storage mediums comprising one or more instructions which when executed by one or more hardware processors perform actions comprising:
receiving, a set of performance data being associated with enterprise operations, wherein the set of performance data includes a structured data, and an unstructured data;
analyzing by a cognitive data analyser, the set of performance data with a set of benchmark value which is an indicative factor of an enterprise operations agility;
computing, a plurality of agility performance parameters based on a deviation identified from the set of performance data compared with the set of benchmark value using an agility recommender technique, wherein the plurality of performance parameters comprises a contextual factor and an affinity factor; and
determining, a set of improvement opportunities to recommend the enterprise operations based on the plurality of agility performance parameters compared with historical data.

16. The one or more non-transitory machine-readable information storage mediums of claim 15, wherein the agility recommender technique comprises:
computing, the contextual factor based on at least one of (i) a plurality of contextual parameters, (ii) a contextual intercept, and (iii) a coefficient of the contextual intercepts, wherein the plurality of contextual parameters are extracted from the set of performance data; and
computing, the affinity factor based on (i) a plurality of affinity parameters, and (ii) a contextual delta.

17. The one or more non-transitory machine-readable information storage mediums of claim 16, wherein the plurality of contextual parameters comprises a team size, a team skill, a line of business, and a technical stack.

18. The one or more non-transitory machine-readable information storage mediums of claim 16, wherein the plurality of affinity parameters comprises (i) a measurement attribute, and (ii) customer feedback.

19. The one or more non-transitory machine-readable information storage mediums of claim 18, wherein the measurement attribute is a weighted average of a plurality of performance attributes falling within a predefined range.

20. The one or more non-transitory machine-readable information storage mediums of claim 19, wherein the measurement attribute is a weighted average of a plurality of performance attributes falling within a predefined range.
